(19) United States
(12) Patent Application Publication
(10) Pub. No.: US 2011/0173966 A1
(43) Pub. Date: Jul. 21, 2011

(54) HYDRAULIC AGREGATE

(76) Inventors: Harald Klahm, St. Ingbert (DE); Frank Liedtke, Kamen (DE)

(21) Appl. No.: 12/737,242

(22) PCT Filed: Apr. 27, 2009
(86) PCT No.: PCT/EP2009/003039

§ 371 Date: Jan. 27, 2011

(30) Foreign Application Priority Data
Jun. 27, 2008 (DE) 10 2008 030 715.7

(51) Int. Cl. F15B 1/26; F04B 23/02

(52) U.S. Cl. 60/477

(57) ABSTRACT

The invention relates to a hydraulic aggregate, particularly for supplying conveyor and lifting devices with pressurized fluid, having a tank (1) on the end side relative to a main axis of the device and functional components mounted thereon, comprising at least one hydraulic pump (5) and one coupling body (3) having a valve device and a line arrangement for drawing in and returning hydraulic fluid to and from the tank (1), characterized in that it is configured as a reversing aggregate, wherein the inlet end (19) of the suction line (15) of the line arrangement is disposed at a location within the tank (1) where the bottom of the fluid present in the tank (1) is located when the aggregate is operated with the main axis vertical and when the aggregate is operated with the main axis tilted relative to the vertical, preferably perpendicular to the vertical.

The invention relates to a hydraulic aggregate, particularly for supplying conveyor and hoisting gear with pressurized fluid, having a tank on the end side relative to a major axis of the device and functional components mounted thereon, comprising at least one hydraulic pump and one connecting body with a valve device and a line arrangement for intake and return of hydraulic fluid to and from the tank.

Hydraulic aggregates of this type are known; see, for example, DE 10 2004 032 256 B3. Such aggregates are used as compact units in various types of conveyor and hoisting gear for actuation of lifting cylinders. The pertinent hydraulic pump is conventionally driven by an electric motor, wherein especially for nonstationary applications, for example, in the actuation of loading platforms, direct current motors are used which can be operated in a power class of about 0.8 kW to 3.0 kW from the pertinent on-board network.

As a result of the diverse fields of application and the resulting different installation situations, such hydraulic aggregates are conventionally implemented in various design concepts, there being fundamental differences especially between versions for installation with a vertical major axis and versions for horizontal installation.

With respect to these problems, the object of the invention is to make available a hydraulic aggregate whose construction makes it possible to cover different installation situations without a change of the design concept being necessary.

This object is achieved according to the invention by a hydraulic aggregate which has the features of claim 1 in its entirety.

Accordingly, one essential particularity of the invention consists in that the entry end of the intake line via which the hydraulic pump takes hydraulic fluid from the tank is situated at that location within the tank at which the bottom of the fluid in the tank is located, regardless of whether the aggregate is installed with the major axis vertical or whether the installation position is horizontal. In this way, a reversible unit in the manner of a modular system is devised with which different situations of use and installation can be covered.

In preferred exemplary embodiments in which the tank has an end wall part on the end side relative to the major axis and at least one other boundary wall part which directly follows it, the arrangement can be made such that the entry end of the intake line is in the transition region from the end wall part and boundary wall part. This ensures that both for a vertical installation position in which the end wall part forms the tank bottom, and also for a horizontal installation position in which the boundary wall part which follows the end wall part forms the tank bottom, the entry end of the intake line is located on the bottom where the fluid is present.

For especially advantageous exemplary embodiments, at least a large part of the tank has a shape inscribed in a cuboid, preferably with a more or less square outline of the end-side end wall part, the entry end of the intake line being located closely adjacent to one corner of the end wall part, that is, in the region of the cuboid on which two wall parts border one another at a right angle, of which, depending on whether the installation position is vertical or horizontal, one of the wall parts forms the tank bottom.

If, in especially advantageous exemplary embodiments, the arrangement is made such that the fill inlet of the tank is on the cover wall of the cuboid, which wall is opposite the end-side end wall part, in the region of that corner which is diagonally opposite the corner assigned to the entry end of the intake line, then not only is there a reversing possibility between the vertical and horizontal installation position, but also for the horizontal installation position the two side walls of the cuboid which border the corner assigned to the entry end of the intake line form the tank bottom. In other words, for the horizontal installation position, there is another reversing possibility, specifically one possible rotation also around the major axis of the device which is horizontal in this case.

For especially preferred exemplary embodiments, the arrangement is made such that for mounting the connecting body on the tank, its cover wall has a round socket which projects from its surface with a flange edge for contact of the connecting flange of the connecting body, there being a tension clip with a hollow section which extends positively over the tank-side flange edge and the connecting flange of the connecting body. In this way, especially simple and reliable linking of the metallic connecting body to a tank which is made of a UV-resistant material, for example, of PE material, is possible without screw fittings being necessary with the disadvantages as ordinarily occur in screw connections between metal bodies and thin-walled plastic bodies.

In advantageous exemplary embodiments, there can be a hood, preferably likewise of UV-resistant plastic, in the form of a cuboid which is open on one side, in which the mounted part located on the tank can be housed, and which with its open side can be mounted on the tank. The linking can likewise take place positively here when a groove-like indentation is formed in the boundary wall parts of the tank which form the side walls of the cuboid, and extends continuously in a plane which is perpendicular to the major axis in the vicinity of the cover wall over the periphery of the cuboid. This indentation in interaction with an end rib which projects to the inside on the end edge which surrounds the open side of the cuboid can form the positive connection by engagement of the end rib of the hood with the indentation of the tank.

To form an essentially smooth box shape of the aggregate, the side walls of the hood mounted on the tank can form planar extensions of the side walls of the cuboid of the tank. Thus a protected (for example, against rock impact and against UV radiation) unit is devised which is closed, except for the accesses to electrical and hydraulic connections.

The invention is detailed below using one exemplary embodiment shown in the drawings.

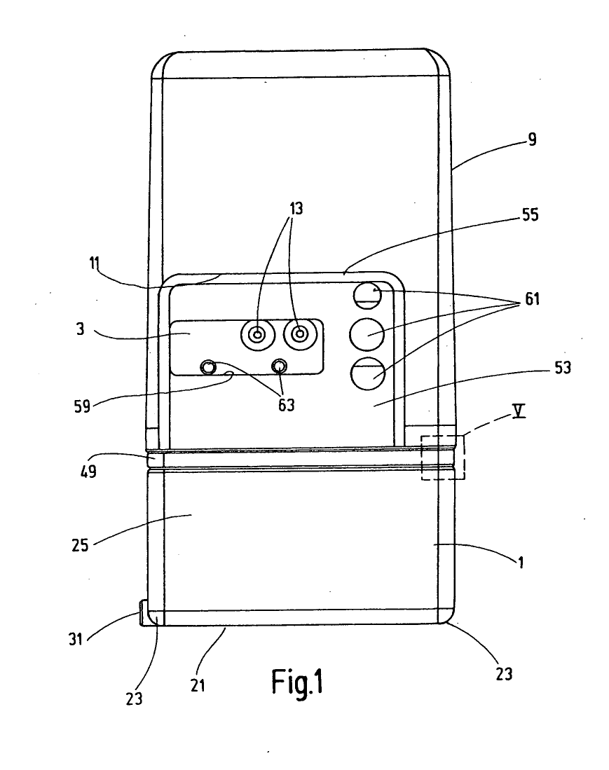

FIG. 1 shows a slightly schematically simplified front view of the exemplary embodiment of the hydraulic aggregate according to the invention, shown in the vertical installation position;

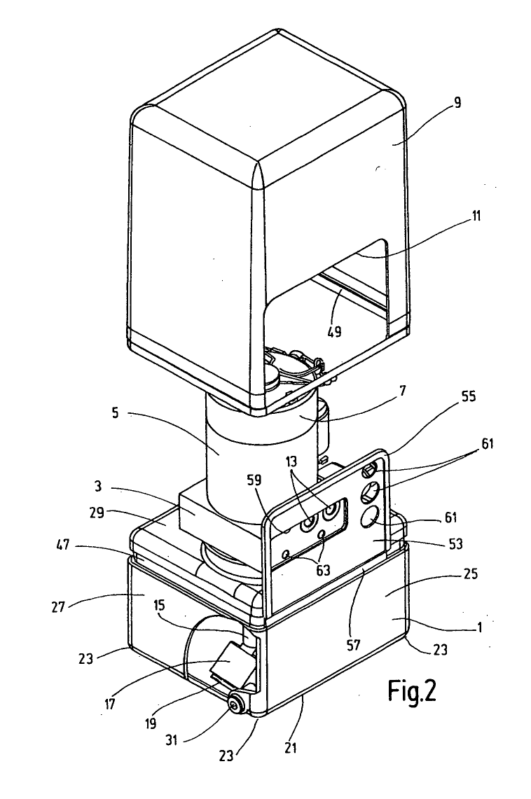

FIG. 2 shows a schematically simplified perspective oblique view of the exemplary embodiment in the vertical installation position, with the hood partially open and the tank shown partially cut away;

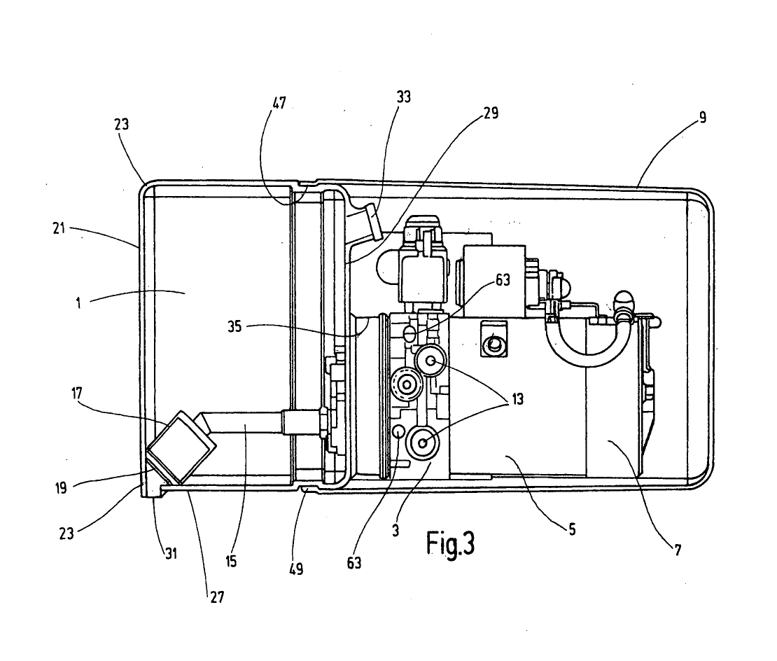

FIG. 3 shows a schematically simplified side view of the exemplary embodiment in the horizontal installation position, one side wall each of the hood and tank being omitted in order to clear a view into the interior;

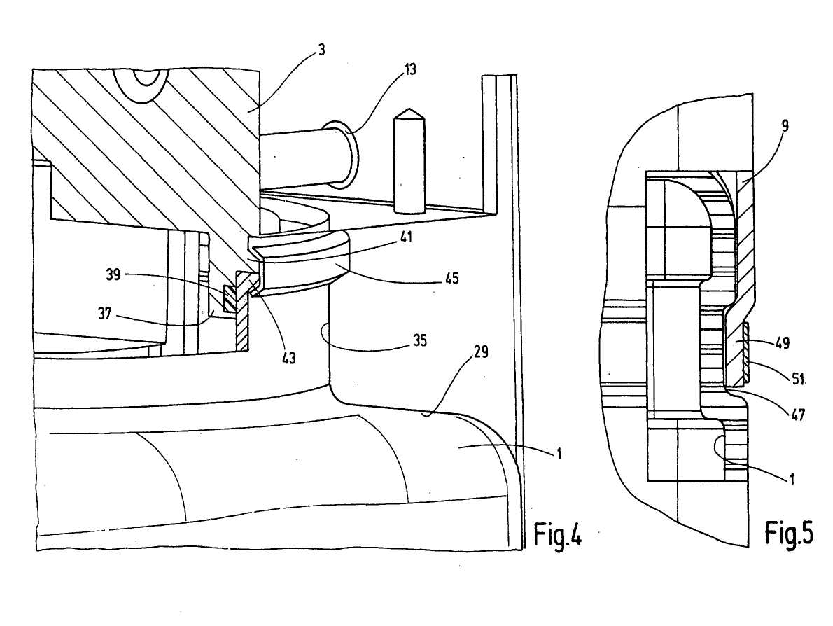

FIG. 4 shows a schematically simplified, enlarged partial representation of only the linking region between the tank and the connecting body, partially cut open, and

FIG. 5 shows a partial extract of only the region designated as V in FIG. 1, which is shown greatly enlarged relative to FIG. 1.

FIGS. 1 to 3 illustrate overall representations of the exemplary embodiment of the aggregate according to the invention, FIG. 1 showing the exemplary embodiment in the closed state, an essentially closed box shape being formed, and FIGS. 2 and 3 being representations drawn partially open, from which inner components can be removed. Proceeding from an end-side tank 1, these components are functional elements which are mounted directly on the tank, specifically a connecting body 3 and a hydraulic pump 5. The latter is an electrically driven motor-pump unit with a DC motor 7. A hood 9 which is shown lifted in FIG. 2 and which has largely the form of a cuboid open on one side, when it is mounted on the tank as shown in FIGS. 1 and 3, forms a jacket for the components mounted on the tank 1, the jacket having on only one side a wall opening 11 which forms a passage for hydraulic and electrical lines to the connecting body 3 and for fasteners which act on the connecting body 3. The connecting body 3 is a metallic valve block with a valve arrangement for controlling hydraulic ports 13 and has a line arrangement for removal and return of hydraulic fluid into and out of the tank 1, of the line arrangement in the figures only one intake line 15 being visible. On the end of the intake line 15 is a suction filter 17 whose filter inlet forms the entry end 19 of the intake line 15.

According to the shape of the hood 9, the tank 1 largely also has the form of a cuboid with an end-side planar end wall 21 which, aside from the rounding on its corners 23, has a rectangular outline which is more or less square. As further boundary wall parts of the tank 1, planar side walls 25 and 27 (FIG. 2) follow and extend to the upper cover wall 29 of the tank 1. As can be taken from FIGS. 2 and 3, the entry end 19 of the intake line 15 is closely adjacent to a corner 23, i.e., in a junction region in which the end wall 21 and the side walls 25 and 27 abut one another. Moreover, in this corner region, there is a fluid drain 31 in the side wall 27. There is a fill inlet 33 which is visible only in FIG. 3 on the cover wall 29 of the tank 1 at a location which is diagonally opposite the entry end 19 of the intake line 15, relative to the cuboidal shape of the tank 1; i.e., in FIG. 3 it is offset into the plane of the drawing to the back relative to the entry end 19 which lies in the plane of the drawing.

In this positioning of the entry end 19 of the intake line 15 and the fill inlet 33, it is ensured that the entry end 19 is located underneath the fluid level present in the tank (1), and the fill inlet 33 is above the fluid level, even if the tank 1 and thus also the hydraulic aggregate as a whole assume different installation positions. FIGS. 1 and 2 show the aggregate in a position corresponding to a vertical installation position in which the end wall 21 forms the tank bottom on which the bottom of the fluid is present. In the horizontal installation position shown in FIG. 3 and in which one side wall 27 forms the tank bottom, the entry end 19 of the intake line 15 is likewise located underneath the fluid level, the fill inlet 33 in turn being located above the fluid level, as in the vertical installation position. In contrast to FIG. 3, for a horizontal installation position the orientation could also be such that the side wall 25 which is visible in FIG. 2 and which is omitted in FIG. 3 forms the tank bottom. Compared to the situation shown in FIG. 3, there is therefore another reversing possibility of rotation around the major axis of the device for a horizontal installation position.

Details of the mounting of the connecting body 3, which is a metallic valve block, are shown in FIG. 4. As shown, on the upper cover wall 29 of the tank 1, a round pipe socket 35 is molded on, which has a comparatively large diameter and which, in the illustrated example, is more than half the width of the tank 1 and which is located offset out of the central region of the cover wall 29, as can be seen from FIG. 3. The intake line 15 and a return line which is not shown extend through the socket 35 to the connecting body 3. The latter has a ring body 37 which engages the socket 35 with a seal 39 and forms a radially projecting connecting flange 41 which adjoins a flange edge 43 of the socket 35. A tension clip 45 which has a hollow profile which is matched to the connecting flange 41 and the flange edge 43 extends positively over the connecting flange 41 and the flange edge 43. A toggle clamp provided on the tension clip 45 is not shown in the figures.

As already mentioned, the hood 9 has the form of a cuboid which is matched to the outside shape of the tank 1, which is open on one side and otherwise, aside from an opening 11, is closed so that in the assembled state the hydraulic aggregate, as shown in FIG. 1, has an essentially closed box shape. To mount the hood 9 on the tank 1, the latter, in the vicinity of its cover wall 29, is provided with an indentation 47 which has the shape of a groove with rounded side walls and which extends continuously over the entire peripheral region of the tank 1. This indentation 47 forms a seat for positive accommodation of an end rib 49 which projects to the inside and which is made on the end edge which surrounds the open side of the cuboid of the hood. This end rib 49 can be snapped into the indentation 47 with slight elastic deformation of the end edge of the hood. For additional security, a metallic tension band 51, see FIG. 5, can be provided which locks the end rib in the indentation 47.

The termination part which is located on the opening 11 with the hood 9 closed is a sheet metal plate 53 in the form of a rounded rectangle whose edge is encompassed on three sides by a U-profile seal 55, which extends on one side wall 25 along the facing end of the connecting body 3 along the major axis. When the hood 9 is in place, the profile seal 55 forms the seal relative to the edge of the opening 11 of the hood 9. The side of the sheet metal plate 53 which borders the tank 1 on the fourth side which is assigned to the tank 1 forms an end edge 57 which is deformed out of the plane of the plate such that the end edge 57 can be positively held in the indentation 47 where it can be secured by cementing or welding. With the hood 9 in place, the end rib 49 of the hood 9 additionally extends over the end edge 57 of the plate 53, optionally with additional locking by an overreaching tension band 51, as shown in FIG. 5.

Viewed in the direction of FIG. 2, in an embodiment which is not further detailed it is also possible to arrange the wall of the hood 9, which wall is the rear wall here, as a guide part in an extension of the side wall 25 of the tank 1, for example, by the rear wall of the hood being secured on the projecting plate 53. In this respect, the remaining three side parts of the hood 9 are then slipped from the top onto the tank 1 and are connected, as described, via longitudinal guides which are located on the end on the end sides of the rear wall. In doing so, viewed in the direction of FIG. 2 the back end wall of the hood 9 can also be an integral component of the projecting plate arrangement 53, which in turn can be secured on the tank 1 and/or on the connecting body 3.

As can be seen from FIGS. 1 and 2, the sheet metal plate 53 has a passage 59 and openings 61. Of the latter, the passage 59 forms an access to the hydraulic ports 13 on the connecting body 3 and to threaded bores 63 in the connecting body 3 which are designed for fastening screws, by which the aggregate can be secured on the pertinent bracket.

As a modular system the invention allows not only the coverage of different installation situations due to the available reversing possibility, but can also be easily adapted to different power classes. Thus, for example, the volume of the tank 1 can be easily matched to the requirements of the hydraulic system by the tank height being increased, only the intake line 15 needing to be provided with a correspondingly greater length. All other components and their linking to the tank 1, in which optionally only the distance between the end wall 21 and the top wall 29 has changed, remain unchanged.

1. A hydraulic aggregate, particularly for supplying conveyor and hoisting gear with pressurized fluid, having a tank (1) on the end side relative to a major axis of the device and functional components mounted thereon, comprising at least one hydraulic pump (5) and one connecting body (3) with a valve device and a line arrangement for intake and return of hydraulic fluid to and from the tank (1), characterized in that it is designed as a reversible aggregate in which the entry end (19) of the intake line (15) of the line arrangement is located within the tank (1) at a site at which the bottom of the fluid in the tank (1) is located in operation of the aggregate with the major axis vertical and in operation of the aggregate with a major axis which is tilted to the vertical, preferably perpendicular to the vertical.

2. The hydraulic aggregate according to claim 1, characterized in that the tank (1) has an end wall part (21) on the end side relative to the major axis and at least one other boundary wall part (25, 27) which directly follows it and that the entry end (19) of the intake line (15) is in the transition region from the end wall part (21) and the boundary wall part (25, 27).

3. The hydraulic aggregate according to claim 2, characterized in that at least a large part of the tank (1) has a shape inscribed in a cuboid, preferably with a more or less square outline of the end-side end wall part (21) and that the entry end (19) of the intake line (15) is located closely adjacent to one corner (23) of the end wall part (21).

4. The hydraulic aggregate according to claim 3, characterized in that a fluid drain (31) is closely adjacent to the corner (23) assigned to the entry end (19) of the intake line (15) in the bordering boundary wall part (25, 27) of the cuboid.

5. The hydraulic aggregate according to claim 4, characterized in that a fill inlet (33) on the cover wall (29) of the cuboid, which wall is opposite the end-side end wall part (21), is in the region of that corner (23) of the cuboid which is diagonally opposite the corner (23) assigned to the entry end (19) of the intake line (15).

6. The hydraulic aggregate according to claim 5, characterized in that for mounting the connecting body (3) on the tank (1), its cover wall (29) has a round socket (35) which projects from its surface with a flange edge (43) for contact of a connecting flange (41) of the connecting body (3) and that there is a tension clip (45) with a hollow section which extends positively over the tank-side flange edge (43) and the connecting flange (41) of the connecting body (3).

7. The hydraulic aggregate according to claim 5, characterized in that there is a hood (9) in the form of a cuboid which is open on one side, in which the mounting parts located on the tank can be housed and which with its open side can be mounted on the tank (1).

8. The hydraulic aggregate according to claim 7, characterized in that a groove-like indentation (47) is formed in the boundary wall parts of the tank (1) which form the side walls (25, 27) of the cuboid, which indentation extends continuously in the plane which is perpendicular to the major axis in the vicinity of the cover wall (29) over the periphery of the cuboid.

9. The hydraulic aggregate according to claim 8, characterized in that the hood (9) on the end edge which surrounds the open side of the cuboid forms an end rib (49) which projects to the inside and which engages the indentation (47) of the tank (1) when the hood (9) is mounted on the tank (1).

10. The hydraulic aggregate according to claim 7, characterized in that the side walls of the hood (9), which is mounted on the tank, form planar extensions of the side walls (25, 27) of the cuboid of the tank (1).
